(19) United States
(12) Patent Application Publication
(10) Pub. No.: US 2006/0253831 A1
(43) Pub. Date: Nov. 9, 2006

(54) Validation architecture

(75) Inventors: Mark D. Harper, Redmond, WA (US); David J. Jenni, Sammamish, WA (US); Namita Gupta, Seattle, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 11/121,670

(22) Filed: May 3, 2005

(51) Int. Cl. G06F 9/44

(52) U.S. Cl. 717/106

(57) ABSTRACT

Architecture for validating input. A control is associated with a data source via a Binding. The control is arranged to receive user input with which to update the data source. In addition, zero or more validation rules are associated with the Binding and executed to validate the input. If the user input is invalid or an exception occurs while converting the input or updating the data source, a validation error object may be created and attached to the control. To provide feedback to the user, a control defines additional user interface elements to adorn the control and display the created validation error information to the user.

### FIELD OF THE INVENTION

The invention relates generally to computers, and more particularly to validation.

### BACKGROUND

Most applications that receive input from users have a validation semantic to ensure that users enter the correct information. The validation may check type, range limitations, or other application specific requirements. More and more application developers are connecting user interface input controls with a data source. Validating input in conjunction with updating a data source introduces additional complexity.

What is needed is an architecture for validating input that is bound to a data source.

### SUMMARY

Briefly, the present invention provides an architecture for validating input. A control is associated with a data source via a Binding. The control is arranged to receive input with which to update the data source. In addition, zero or more validation rules are associated with the Binding and executed to validate the input. If the input is invalid or an exception occurs while converting the input or updating the data source, a validation error object may be created and attached to the control.

Other aspects will become apparent from the following detailed description when taken in conjunction with the drawings, in which:

### BRIEF DESCRIPTION OF THE DRAWINGS

FIG. 1 is a block diagram representing a computer system into which the present invention may be incorporated;

FIGS. 2A-6B are block diagrams generally representing exemplary application programming interfaces that may operate in accordance with various aspects of the invention;

FIGS. 7 and 8 are block diagrams that generally represent how a compiler or interpreter may transform one or more interfaces to one or more other interfaces in accordance with various aspects of the invention;

FIG. 9 is a block diagram representing an exemplary environment in which the present invention may operate in accordance with various aspects of the invention;

FIG. 10 is a flow diagram generally representing actions that may occur when updating a data source associated with a control via a Binding in accordance with various aspects of the invention; and

FIG. 11 is a flow diagram generally representing actions corresponding to block 1015 of FIG. 10 that may occur when executing validation rules in accordance with various aspects of the invention.

### DETAILED DESCRIPTION

Exemplary Operating Environment

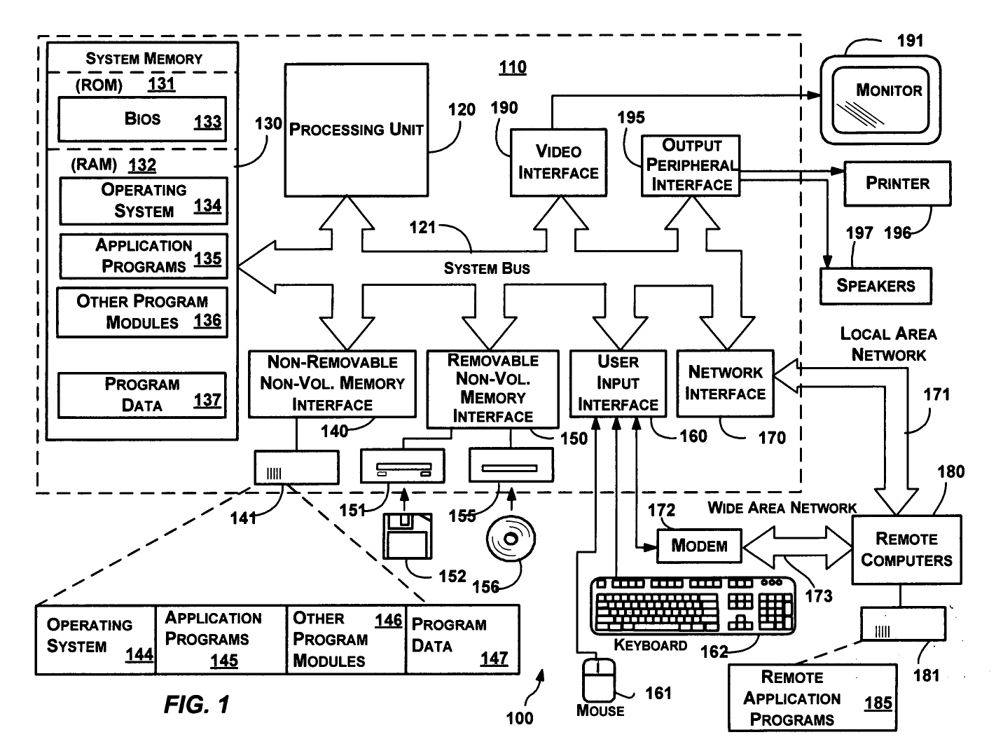

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microcontroller-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, a touch-sensitive screen of a handheld PC or other writing tablet, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Interfaces

A programming interface (or more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), and the like of a component of a system capable of communicative coupling to one or more mechanism(s), method(s), function call(s), module(s), and the like of other component(s). The term “segment of code” is intended to include one or more instructions or lines of code, and includes, for example, code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software.

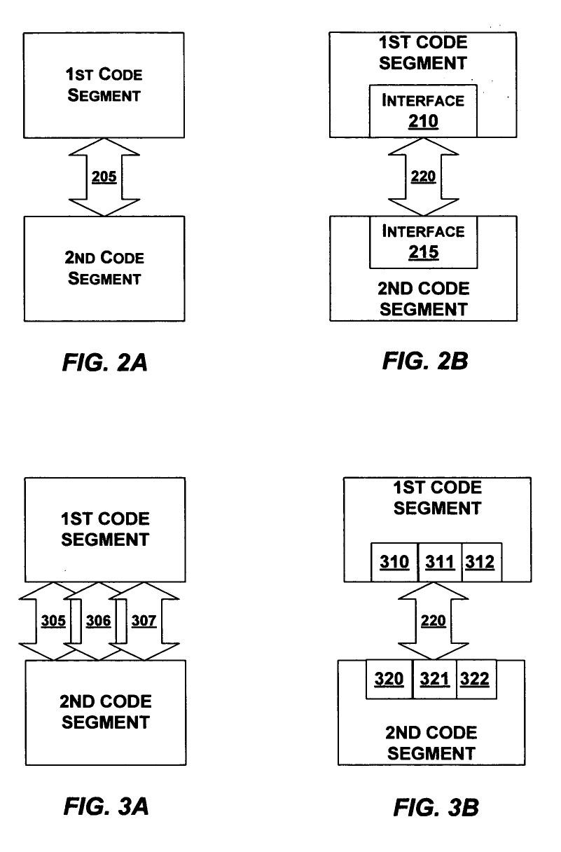

Notionally, a programming interface may be viewed generically, as shown in FIG. 2A or FIG. 2B. FIG. 2A illustrates an interface 205 as a conduit through which first and second code segments communicate. FIG. 2B illustrates an interface as comprising interface objects 210 and 215 (which may or may not be part of the first and second code segments), which enable first and second code segments of a system to communicate via medium 220. In the view of FIG. 2B, one may consider interface objects 210 and 215 as separate interfaces of the same system and one may also consider that objects 210 and 215 plus medium 220 comprise the interface. Although FIGS. 2A and 2B show bi-directional flow and interfaces on each side of the flow, certain implementations may only have information flow in one direction (or no information flow as described below) or may only have an interface object on one side. By way of example, and not limitation, terms such as application programming interface (API), entry point, method, function, subroutine, remote procedure call, and component object model (COM) interface, are encompassed within the definition of programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment simply accesses functionality performed by a second code segment. Any or all of these aspects may be important in a given situation, for example, depending on whether the code segments are part of a system in a loosely coupled or tightly coupled configuration, and so this list should be considered illustrative and non-limiting.

This notion of a programming interface is known to those skilled in the art and is clear from the foregoing detailed description. There are, however, other ways to implement a programming interface, and, unless expressly excluded, these too are intended to be encompassed by the claims set forth at the end of this specification. Such other ways may appear to be more sophisticated or complex than the simplistic view of FIGS. 2A and 2B, but they nonetheless perform a similar function to accomplish the same overall result. Below are some illustrative alternative implementations of a programming interface.

A. Factoring

A communication from one code segment to another may be accomplished indirectly by breaking the communication into multiple discrete communications. This is depicted schematically in FIGS. 3A and 3B. As shown, some interfaces can be described in terms of divisible sets of functionality. Thus, the interface functionality of FIGS. 2A and 2B may be factored to achieve the same result, just as one may mathematically provide 24 as 2 times 2 times 3 times 2. Accordingly, as illustrated in FIG. 3A, the function provided by interface 205 may be subdivided to convert the communications of the interface into multiple interfaces 305, 306, 307, and so on while achieving the same result.

As illustrated in FIG. 3B, the function provided by interface 210 may be subdivided into multiple interfaces 310, 311, 312, and so forth while achieving the same result. Similarly, interface 215 of the second code segment which receives information from the first code segment may be factored into multiple interfaces 320, 321, 322, and so forth. When factoring, the number of interfaces included with the 1^{st} code segment need not match the number of interfaces included with the 2^{nd} code segment. In either of the cases of FIGS. 3A and 3B, the functional spirit of interfaces 205 and 210 remain the same as with FIGS. 2A and 2B, respectively.

The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

B. Redefinition

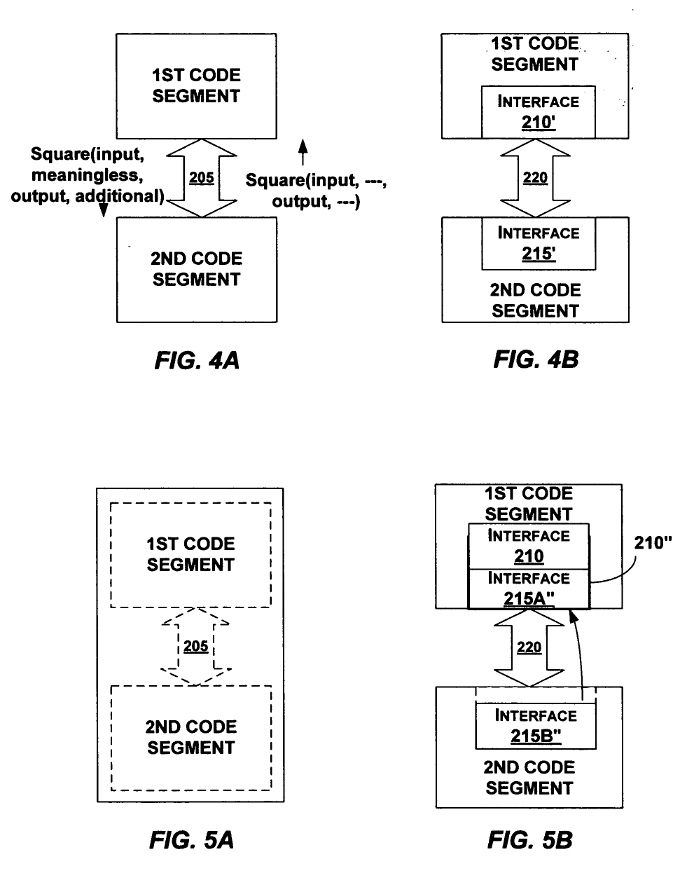

In some cases, it may be possible to ignore, add, or redefine certain aspects (e.g., parameters) of a programming interface while still accomplishing the intended result. This is illustrated in FIGS. 4A and 4B. For example, assume interface 205 of FIG. 2A includes a function call Square(input, precision, output), that includes three parameters, input, precision and output, and which is issued from the 1^{st} Code Segment to the 2^{nd} Code Segment. If the middle parameter precision is of no concern in a given scenario, as shown in FIG. 4A, it could just as well be ignored or even replaced with a meaningless (in this situation) parameter. An additional parameter of no concern may also be added. In either event, the functionality of square can be achieved, so long as output is returned after input is squared by the second code segment.

Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 4B, interface 210 is replaced by interface 210′, redefined to ignore or add parameters to the interface. Interface 215 may similarly be redefined as interface 215′, redefined to ignore unnecessary parameters, or parameters that may be processed elsewhere. As can be seen, in some cases a programming interface may include aspects, such as parameters, that are not needed for some purpose, and so they may be ignored or redefined, or processed elsewhere for other purposes.

C. Inline Coding

It may also be feasible to merge some or all of the functionality of two separate code modules such that the “interface” between them changes form. For example, the functionality of FIGS. 2A and 2B may be converted to the functionality of FIGS. 5A and 5B, respectively. In FIG. 5A, the previous 1^{st} and 2^{nd} Code Segments of FIG. 2A are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface 205 may still be in effect. Similarly, shown in FIG. 5B, part (or all) of interface 215 from FIG. 2B may be written inline into interface 210 to form interface 210″. As illustrated, interface 215 is divided into 215A″ and 215B″, and interface portion 215A″ has been coded in-line with interface 210 to form interface 210″.

For a concrete example, consider that the interface 210 from FIG. 2B may perform a function call square (input, output), which is received by interface 215, which after processing the value passed with input (to square it) by the second code segment, passes back the squared result with output. In such a case, the processing performed by the second code segment (squaring input) can be performed by the first code segment without a call to the interface.

D. Divorce

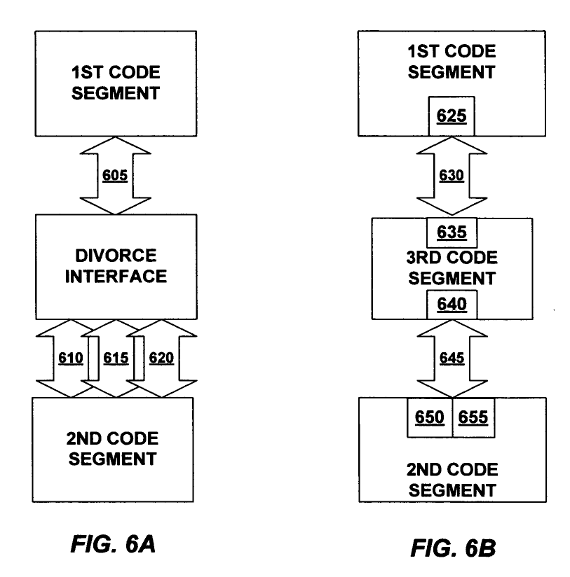

A communication from one code segment to another may be accomplished indirectly by breaking the communication into multiple discrete communications. This is depicted schematically in FIGS. 6A and 6B. As shown in FIG. 6A, one or more piece(s) of middleware (Divorce Interface(s), since they divorce functionality and/or interface functions from the original interface) are provided to convert the communications on the first interface 605, to conform them to a different interface, in this case interfaces 610, 615, and 620. This might be done, for example, where there is an installed base of applications designed to communicate with, say, an operating system in accordance with an the first interface 605's protocol, but then the operating system is changed to use a different interface, in this case interfaces 610, 615, and 620. It can be seen that the original interface used by the 2^{nd} Code Segment is changed such that it is no longer compatible with the interface used by the 1^{st} Code Segment, and so an intermediary is used to make the old and new interfaces compatible.

Similarly, as shown in FIG. 6B, a third code segment can be introduced with divorce interface 635 to receive the communications from interface 630 and with divorce interface 640 to transmit the interface functionality to, for example, interfaces 650 and 655, redesigned to work with 640, but to provide the same functional result. Similarly, 635 and 640 may work together to translate the functionality of interfaces 210 and 215 of FIG. 2B to a new operating system, while providing the same or similar functional result.

E. Rewriting

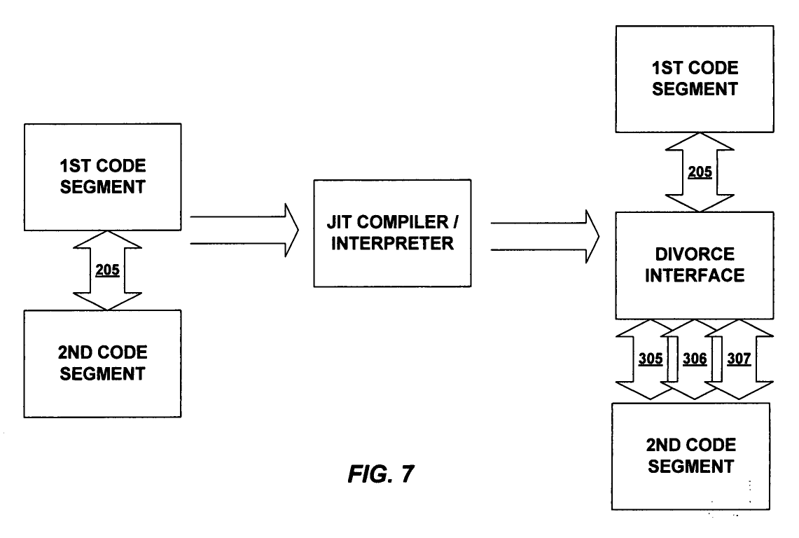

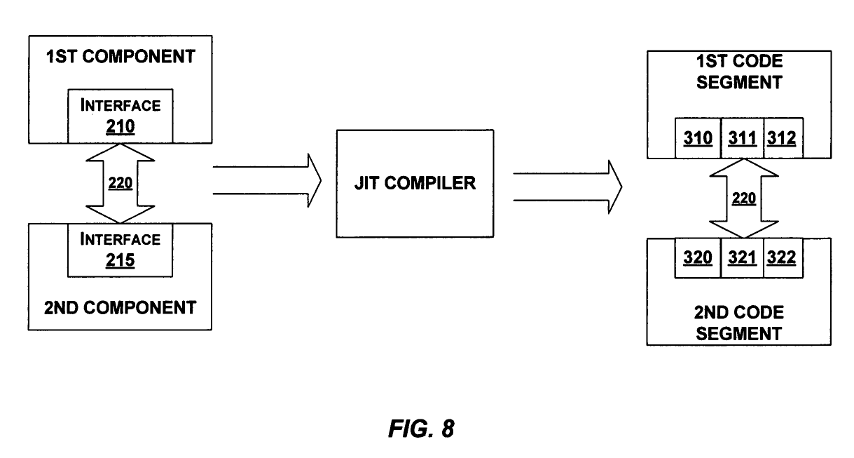

Yet another possible variant is to dynamically rewrite the code to replace the interface functionality with something else but which achieves the same overall result. For example, there may be a system in which a code segment presented in an intermediate language (e.g. Microsoft IL, Java® ByteCode, etc.) is provided to a Just-in-Time (JIT) compiler or interpreter in an execution environment (such as that provided by the Net framework, the Java® runtime environment, or other similar runtime type environments). The JIT compiler may be written so as to dynamically convert the communications from the 1^{st} Code Segment to the 2^{nd} Code Segment, i.e., to conform them to a different interface as may be required by the 2^{nd} Code Segment (either the original or a different 2^{nd} Code Segment). This is depicted in FIGS. 7 and 8.

As can be seen in FIG. 7, this approach is similar to the Divorce scenario described above. It might be done, for example, where an installed base of applications are designed to communicate with an operating system in accordance with a first interface protocol, but then the operating system is changed to use a different interface. The JIT Compiler may be used to conform the communications on the fly from the installed-base applications to the new interface of the operating system. As depicted in FIG. 8, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched, and combined to produce the same or equivalent scenarios to the generic scenarios presented in FIGS. 2A and 2B. It is also noted that, as with most programming constructs, there are other similar ways of achieving the same or similar functionality of an interface which may not be described herein, but nonetheless are represented by the spirit and scope of the invention, i.e., it is noted that it is at least partly the functionality represented by, and the advantageous results enabled by, an interface that underlie the value of an interface.

Validation Architecture

Applications may have a variety of validation errors based on their application specifics which may appear at different levels. At the property level, a control or element (hereinafter referred to as “control”) may experience validation errors during editing, type coercion, conversion, setting data, and the like. For example, a textbox control may allow only integers to be entered and may have a validation error if a user attempts to enter other characters.

As an example of type coercion validation errors, there may be type incompatibility between what is input and the property type of a property. For example, a user may input a name into a textbox control that receives data for an integer.

Even if data in a control passes various property validation checks, it may still fail a business validation check. For example, a number entered into a text control may consist of digits but may not be a valid credit card number.

In addition to the property level, validation may also be performed at the object level. For example, the fields of an address may comprise an address object. Before the address object is updated with the fields, a check as to whether the address represents an actual address may be performed.

Object level validation may be performed at various times including, for example, before transferring values to the object, before adding an object to a collection, before adding collection to a data store, and so forth.

Another validation may occur in composite controls. A composite control is a control (sometimes called a parent control) comprised of other controls (sometimes called children controls). The parent control may wish to know when any children have invalid data so that the parent control may then show some error message.

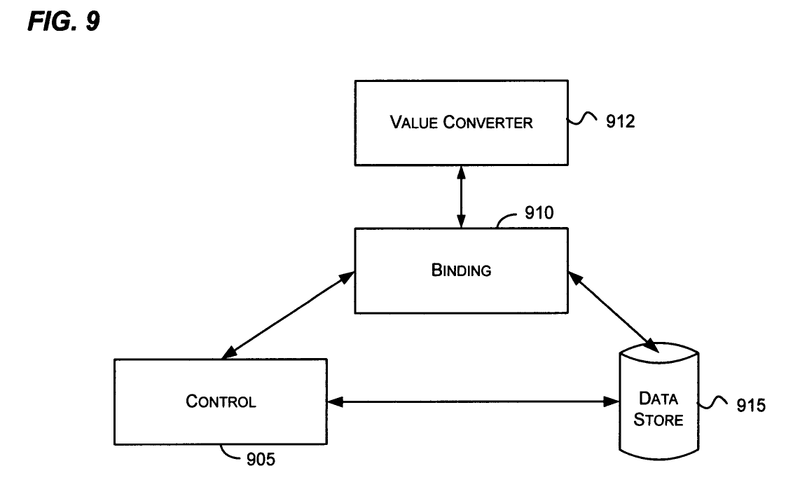

FIG. 9 is a block diagram representing an exemplary environment in which the present invention may operate in accordance with various aspects of the invention. The environment may include a control 905, a Binding 910, a value converter 912, and a data store 915.

The control 905 comprises an object that includes code to display a user interface element and receive input. The Binding 910 associates the control 905 with a data store 915. The Binding may include a property (e.g., ValidationRules) which defines a set of validation rules that validate a value before the value is transferred from the control 905 to the value converter 912 (if it exists) or back to the data source 915.

The set of validation rules may include zero or more rules. Each validation rule may provide its own error message. The validation rules may be executed in the order in which they are specified. Typically, the validation rules execute before values are passed to the value converter 912.

In one embodiment, the first validation rule to return invalid ends the validation process and sets the state of the Binding in error. In another embodiment, validation continues until all rules have been evaluated and a collection of errors may accumulate when one or more rules return invalid.

Each validation rule may provide a validate method which may be called to validate the input. An exemplary validation rule interface is as follows:

```
public interface IValidationRule
{
  ValidationResult Validate(object value, CultureInfo
    cultureInfo);
}
public class ValidationResult
{
  bool IsValid{get; }
  object ErrorContent{get; }
}
```

The object value passed into the IValidationRule interface may include the value of the item to validate while CultureInfo may indicate information about the country or culture associated with the rule.

The most common examples of the object of ErrorContent comprise an exception or a string, although the object of ErrorContent is not limited to these examples and may, for example, include anything that may be represented by an object.

The Binding 910 may associate the control 905 with one or more fields in the data store 915. When the Binding 910 associates the control 905 with only one field, the Binding 910 is sometimes referred to as a simple binding. When the Binding 910 associates the control 905 with two or more fields, the Binding 910 is sometimes referred to as MultiBinding. For example, in MultiBinding, the Binding 910 may associate a control 905 that displays “Last_Name, First_Name” with two fields (e.g., Last_Name and First_Name) in the data store 915.

MultiBinding may have one or more inner Bindings and may aggregate the values of all of its inner Bindings into a single value by calling an application supplied multi-value converter (e.g., MultiValueConverter). In a MultiBinding there may be a validation rules set associated with the MultiBinding itself and/or on any of its inner Bindings. The validation rules associated with the MultiBinding may be evaluated when a value is transferred from the control 905 into a multi-value converter. The validation rules on the inner Bindings may be evaluated when a value is transferred from the multi-value converter to the data source field associated with an inner bind.

Below is a table that indicates various states of errors associated with a MultiBinding in accordance with various aspects of the invention.

| | MultiBinding not | MultiBinding | MultiBinding in | MultiBinding in |
|---|---|---|---|---|
| | in error, all | not in error, at | error, all | error, and at least |
| | Bindings not in | least one | Bindings not in | one Binding in |
| | error | Binding in error | error | error |
| Validation. | FALSE | TRUE | TRUE | TRUE |
| HasErrorProperty | | | | |
| MultiBinding. | FALSE | FALSE | TRUE | TRUE |
| HasError | | | | |
| MultiBinding. | Null | null | The error of the | The error of the |
| ValidationError | | | MultiBinding | MultiBinding |
| Validation. | empty collection | One or more | The | In one |
| ErrorsProperty | | errors per | MultiBinding | embodiment, only |
| | | Binding that is | error is added | the error from the |
| | | not valid | to this | MultiBinding is |
| | | | collection | added to this |
| | | | | collection |

The Binding 910 may provide an interface that allows marking the Binding 910 as being in error as well as clearing any error in the Binding 910. This may be useful, for example, when an application wishes to mark the Binding 910 as invalid as a result of an error or exception that occurs when converting or setting the data or when transferring the data to the data store 915. In one embodiment, if an application marks the Binding 910 as invalid more than once with different errors, the last error set is the one that remains associated with the Binding 910.

In addition, the Binding 910 may also provide an exception filter callback, which is called whenever an exception is encountered when trying to convert the value or update the value to the data store 915. An application author may provide a handler for handling exceptions here. If the handler returns:

a. Null. The Binding 910 does not throw an exception and does not create a validation error.

b. The exception itself. The Binding 910 may throw the exception using an asynchronous exception model, for example.

c. A non-null object. The Binding 910 may create a validation error and set the ErrorContent of the validation error to the returned object.

d. A validation error. The Binding 910 may set itself as BindingInError, ensure that appropriate properties are set, and add the validation errors to the validation error collection on the control that has the Binding.

If an exception filter is not provided, any exception may be wrapped in a validation error and set on the control 905.

In case of a MultiBinding, the most closely associated exception filter may be executed. For example, if an exception occurs when updating the source on an inner Binding, the exception filter on that Binding, if it exists, may be called, otherwise, the exception filter associated with the MultiBinding, if it exists, may be called.

An exemplary interface for marking and clearing validation errors and working with exception filters for Binding and MultiBinding may comprise:

```
public class Binding/MultiBinding
{
  //instance methods to set and clear valid state.
  public void MarkInvalid(ValidationError error);
  public void ClearInValid(ValidationError error);
  public ValidationError ValidationError{get;}
  public UpdateSourceExceptionFilterCallback
    UpdateSourceExceptionFilter;
  public delegate object
    UpdateSourceExceptionFilterCallback(Exception
    exception);
}
```

Setting a Validation Error

When the Binding 910 associated with the control 905 is in error, the Binding 910 may set a ValidationError property on the Binding 910, and add the error to a Validation.Errors attached property on the control 905. An attached property is a property that may not already exist on the control 905. Attaching a property to the control 905 allows the property to be accessed via the attached property's name just like any other already-existing property of the control 905.

When the Binding 910 produces a ValidationError, it sets the BindingInError property on the error to itself. Information about the Binding 910 (e.g., property, object, data, and so forth) may be accessed from this property. An exemplary interface for working with validation errors may comprise:

```
public class ValidationError
{
  public IValidationRule RuleInError{get;set;}
  object ErrorContent{get;set;}
  public Exception Exception{get;set;}
  public Binding BindingInError {get;}
}
```

Steps for Updating Data Source

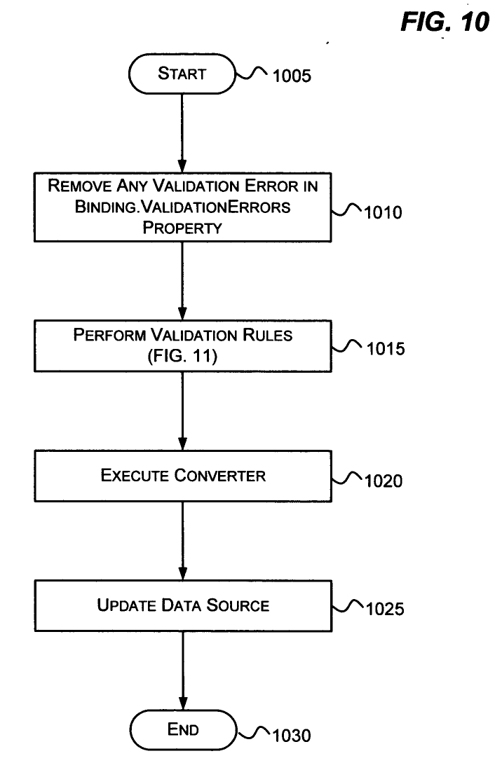

FIG. 10 is a flow diagram generally representing actions that may occur when updating a data source associated with a control via a Binding in accordance with various aspects of the invention. At block 1005, the actions start.

At block 1010, when a Binding attempts to update data it first removes any validation error that it may have added to a control's Validation.Errors property.

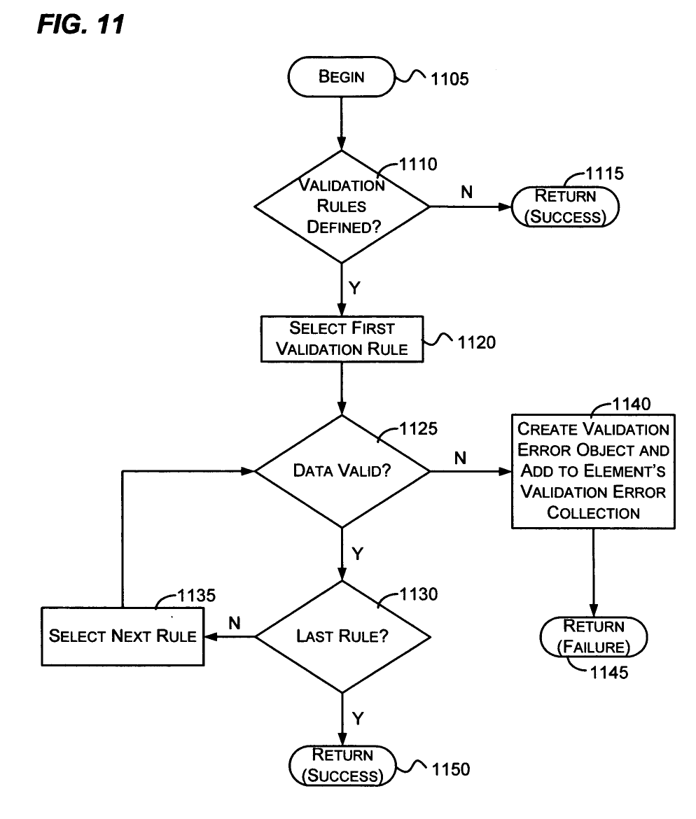

At block 1015, validation rules, if any, are performed as described in more detail in conjunction with FIG. 11. At block 1020, a value converter, if it exists, is executed to convert the value in the control into a value appropriate for the data source. For example, a string “123” may be converted into a double “123.00”. At block 1025, the data source is updated.

In some embodiments, the actions associated with block 1020 may be performed before the actions associated with block 1015.

In one embodiment, whenever an error occurs (e.g., while executing validation rules, executing the converter, or updating the data source), the Binding is set as having an error and an error object is created and added to an errors collection and attached a property of the control. After this is done, the actions end without attempting to perform other validation rules, if any, executing the converter, or updating the data source. Thus, in this embodiment, implicit in proceeding to the actions associated with a subsequent block is that the actions associated with the current block completed successfully.

Executing a validation rule refers to determining whether a value is valid based on the validation rule. It may involve executing code and/or applying a set of checks to the value. For example, in a range validation rule, the value may be checked against endpoints of the range to determine whether the value falls within the range. In a credit card validation rule, the value may be checked with a credit card company or other database to determine whether it is valid.

If an exception is thrown in the converter or while updating the data source, the Binding may call an exception filter to give the application an opportunity to handle the exception; otherwise, the Binding may create a validation error object with the exception and add it to the control's validation error collection.

At block 1030, the actions end.

FIG. 11 is a flow diagram generally representing actions corresponding to block 1015 of FIG. 10 that may occur when executing validation rules in accordance with various aspects of the invention. At block 1105, the actions begin.

At block 1110, a determination is made as to whether there are any validation rules defined in the Binding. If so, the actions continue at block 1120; otherwise, the actions continue at block 1115. At block 1115, the actions return to block 1015 of FIG. 10 with a return code of success.

At block 1120, the first validation rule is selected. As mentioned previously, the validation rules may be executed in a particular order.

At block 1125, a determination is made as to whether the data passes the selected validation rule. If so, the actions continue at block 1130; otherwise, the actions continue at block 1140. The determination made be made by calling a Validate() method on the selected validation rule.

At block 1130, a determination is made as to whether the selected rule is the last validation rule associated with the Binding. If so, the actions continue at block 1150; otherwise, the actions continue at block 1135.

At block 1135, the next validation rule is selected. The actions associated with blocks 1125-1135 may repeat until all rules have been selected (or until the data does not pass one of the rules).

At block 1140, a validation error object is created and added to the control's validation error collection. Other properties on the Binding and control may also be set (e.g., HasError, etc.) At block 1145, the actions return to block 1015 of FIG. 10 with a return code of failure.

At block 1150, the actions return to block 1015 of FIG. 10 with a return code of success.

The validation rules may be executed each time an input value in the control is transferred to the associated underlying data store. Possible modes of update comprise:

1. Immediate: The Binding tries to update the data in the data source with each keystroke or change to the data bound target property. The validation rules may be executed once for each change.

2. OnLostFocus: The Binding tries to update data in the data source once a user has entered the data and tries to change focus away from the input control. This may be used when the user wishes validation to occur on a per field level.

3. Explicit: In this case, the application explicitly calls for an update (e.g., in a click event handler). If the application wishes to do a group update and to do some validation checks based on values of input values of multiple controls, then the group validation logic may go here.

The Binding may provide a property that allows an application to specify the mode of update.

Reporting a Validation Error

A Binding may report an error through an attached property of a corresponding control. Each time a Binding is in error, the Binding may add a validation error object to a validation error collection. When the Binding becomes valid again, the Binding may then remove the error object from the collection. A property (e.g., Validation.HasError) may be set to true if the validation error collection is not empty.

An exemplary interface for reporting validation errors may comprise:

```
public class Validation
{
  //attached properties HasError and Errors.
  public static DependencyProperty HasErrors;
  public static ReadOnlyCollection<ValidationError> Errors;
  public static bool GetHasError(DependencyObject d);
  public static ReadOnlyCollection<ValidationError>
    GetErrors(DependencyObject d);
}
```

In addition, a Binding may include a flag which can be set if the application wishes the Binding to raise an event each time its valid state changes. If this flag is set, then each time a Binding is invalid, the binding may raise a validation error event. This validation error event may carry information about the Binding in error as well as an exception and/or error message. An exemplary flag on the Binding for indicating to raise an event each time the Binding's valid state changes may comprise:

public class Binding
{
public bool NotifyOnValidationError;
}

An exemplary interface for routing and clearing validation events may comprise:

public class ValidationErrorEventArgs
{
public ValidationError Error {get;}
}

public RoutedEvent ClearValidationErrorEvent;

Each time a Binding become valid again, the Binding may raise another event with the same arguments to indicate that the error is no longer relevant. The routed event may notify the control or any of its ancestors each time a validation even occurs. If a control is not listening to a routed event, the control's parent may be notified of the event. If the control's parent is not listening to the routed event, its parent and so forth may be notified of the event until an ancestor is found that will consume the event.

This may be used, for example, when a parent control may wish to listen and perform actions based on the validation errors of its children. The parent control may change the look of the user interface or take other actions based on the event property. For example, if a grid parent control is notified when any of its cells are in error, the grid parent control may highlight (e.g., in red), the row including the cell.

Exemplary Validation Rules

Some exemplary validation rules may include a regular expression rule, a custom rule, a required field rule, and a range rule. A regular expression rule may use a regular expression to validate data. An exemplary interface for a regular expression rule may comprise:

```
public RegularExpressionRule:IValidationRule
{
  //IValidationRule apis omitted here
  public string Expression{get;set;}
  public object ErrorContent{get;set;}
}
```

An exemplary regular expression (specified in a markup language) may comprise:

```
<TextBox>
  <TextBox.TextContent>
    <Binding Path=”Name”>
      <Binding.ValidationRules>
        <RegularExpressionRule Expression=”/d{5}” />
      </Binding.ValidationRules>
    </Binding>
  </TextBox.TextContent>
</TextBox>
```

A custom rule may allow custom validation code to execute to validate data. For example, a custom rule may validate a credit card number. It will be recognized that any custom rule may be created by creating code and associating it with a validation rule without departing from the spirit or scope of the present invention. An exemplary interface for a custom rule may comprise:

```
public CustomRule:IValidationRule
{
  public ValidateCallback Validate{get;set;}
}
public delegate ValidationResult ValidateCallback(object
  value);
```

Exemplary markup language for the custom rule may comprise:

```
<TextBox>
  <TextBox.TextContent>
    <Binding Path=”Name”>
      <Binding.ValidationRules>
        <CustomRule Validate=”myCallback” />
      </Binding.ValidationRules>
    </Binding>
  </TextBox.TextContent>
</TextBox>
<code:Source>
  <![CDATA[
    ValidationResult MyCallback(object value)
    {
      //put in validation code
    }
]]>
```

A validation rule may specify a required field. An exemplary interface for a required field validation rule may comprise:

```
public RequiredFieldRule:IValidationRule
{
    //IValidationRule apis
    public string InitialValue{get;set;}
}
```

Exemplary markup language for the required field rule may comprise:

```
<TextBox>
    <TextBox.TextContent>
        <Binding Path=“Name”>
            <Binding.ValidationRules>
                <RequiredFieldRule InitialValue=“-SelectValue---”/>
            </Binding.ValidationRules>
        </Binding>
    </TextBox.TextContent>
</TextBox>
```

A validation rule may specify a range check. An exemplary interface for a range check validation rule may comprise:

```
public RangeRule:IValidationRule
{
    //IValidationRule apis
    public string MaximumValue{get;set;}
    public string MinimumValue{get;set;}
    public string Type{get;set;}
    public object ErrorContent{get;set;}
}
```

Exemplary markup language for the range check rule may comprise:

```
<TextBox>
  <TextBox.TextContent>
    <Binding Path=”Name”>
      <Binding.ValidationRules>
        <RangeRule MinimumValue=”0” MaximumValue=”1000”
            Type=”int” ErrorContent= “Value must lie between 0
            and 1000”/>
      </Binding.ValidationRules>
    </Binding>
  </TextBox.TextContent>
</TextBox>
```

It will readily be recognized that other rules may also be used without departing from the spirit or scope of the invention.

Displaying Errors

In one embodiment, the control may display a valid/invalid state by the way it looks or through a tool tip associated with the control. For example, the control may display a red background when validation errors occur and a normal background otherwise. As another example, a normal tool tip may be displayed when the control is hovered over and the Binding is valid and an error tool tip may be displayed when the control is hovered over and the Binding is invalid.

Because the Binding attaches both a Validation.HasError property as well as a Validation.Errors property to the control when the Binding is in error, property triggers in styles may be used to change the look of the UI based on these properties. An exemplary style for causing a textbox to render its background in red and to show a tool tip with the error message if a validation error has occurred may comprise:

```
<Style>
  <TextBox/>
    <Style.VisualTriggers>
      <PropertyTrigger Property=”Validation.HasError”
          Value=”True”>
        <Set Property=”Background” Value=”Red”/>
        <Set Property=”ToolTip” Value=”*Binding(Path=(
          Validation.Errors)[0].ErrorMessage;
          ElementSource=/StyledParent)
      </PropertyTrigger>
    </Style.VisualTriggers>
</Style>
```

In another embodiment, an adorner may be used to display error graphics for controls with validation errors. For example, when a validation error occurs, an adorner may display a rectangle around a textbox, an exclamation mark next to a textbox, a circle around a radio button, and so forth.

An adorner may be a class that may be styled. It may be associated with any editable control so that when the control goes into an invalid state, the Binding may choose to show an error user interface using the adorner. The size and where an adorner is displayed may be defined relative to its associated control.

Whenever an editable control is in invalid state a templated adorner may be created and become visible on that control. An application author may set the Validation.ErrorTemplate property on the editable control to define what the error user interface including the templated adorner looks like.

In addition, the context of a visual tree of the templated adorner may be set to the validation error collection associated with the control, so that an application author may display any specific information/tooltip with error information using a Binding.

An adorner placeholder may be indicated in a user interface markup language to indicate where the control on which the adorner is being applied is placed with respect to the other parts of the adorner. The size of the adorner may be determined during a layout pass when the adorner tries to draw itself on the control. In the pass, the adorner may query the control to determine the control's size and may draw itself with respect to the control.

An example of markup language to define some adorners follows:

```
<DockPanel>
<DockPanel.Resources>
<!-to create a red box around the TextBox->
<ControlTemplate x:Key=“RedBox” TargetType=“{x:Type Control}”>
  <Border BorderThickness=“2” BorderBrush=“Red”>
  <AdornerPlaceholder />
  </Border>
</ControlTemplate>
<!-to create an exclamation mark to the right of the TextBox->
<ControlTemplate x:Key=“ExclamationPoint” TargetType=“{x:Type
    Control}”>
  <DockPanel>
    <TextBlock DockPanel.Dock=“Right”>!</TextBlock>
    <AdornerPlaceholder />
  </DockPanel>
</ControlTemplate>
<!-to put an asterisk above and to the right of the TextBox->
<ControlTemplate x:Key=“Star” TargetType=“{x:Type Control}”>
  <Grid>
    <TextBlock HorizontalAlignment=“Right”
        VerticalAlignment=“Top”>*
    </TextBlock>
    <AdornerPlaceholder Margin=“5”/>
  </Grid>
</ControlTemplate></DockPanel.Resources>
<!-to select which templated adorner to use->
<TextBox Validation.ErrorTemplate=“{DynamicResource RedBox}”/>
</DockPanel>
```

In another embodiment, a user interface may provide an indication of validity/non-validity of data in a control by creating another control and having its visibility bound to the IsValid property of the control. For example,

<Image Visibility=”*Binding(Path=Validation.HasError ;
ElementID=x)”/>
<TextBox ID=”x”/>

As can be seen from the foregoing detailed description, there is provided an architecture for validating input. While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer-readable medium having computer-executable instructions, comprising:
associating a control with a data source via a Binding, wherein the control is arranged to receive user input with which to update the data source;
associating a validation rule with the Binding; and
executing the validation rule to validate the input.

2. The computer-readable medium of claim 1, further comprising creating a validation error object and attaching it to the control.

3. The computer-readable medium of claim 1, further comprising setting a property on the control to indicate whether the input passes the validation rule.

4. The computer-readable medium of claim 1, further comprising executing an exception filter in response to an exception encountered when trying to update the data source with the input.

5. The computer-readable medium of claim 4, wherein the exception filter returns a value that causes the Binding to:
not throw an exception and not create a validation error;
throw the exception using an asynchronous exception model;
create a validation error based on an object accessible through the value; or
add a validation error referenced by the value to a validation error collection.

6. The computer-readable medium of claim 1, wherein any exceptions that occur while updating the data source are placed in a validation error and set on the control.

7. The computer-readable medium of claim 1, wherein the binding comprises a MultiBinding that associates the control with two or more fields in the data source.

8. The computer-readable medium of claim 7, wherein the MultiBinding includes multiple inner bindings, and wherein there is a first set of validation rules associated with the MultiBinding and a second set of validation rules associated with one of the inner bindings.

9. The computer-readable medium of claim 8, wherein the first set of validation rules is executed when a value is transferred from the control into a multi-value converter and wherein the second set of validation rules is executed when a valued is transferred from the multi-converter to a data source field associated with the one of the inner bindings.

10. The computer-readable medium of claim 1, wherein the validation rule comprises a custom rule executed via a callback provided to an interface.

11. The computer-readable medium of claim 1, further comprising displaying an element on a user interface via an adorner that is associated with the control.

12. The computer-readable medium of claim 12, further comprising displaying the element via the adorner in conjunction with a property trigger that monitors a property that indicates the validity of the binding.

13. In a computing environment, a method, comprising:
validating input entered into a control via a validation rule;
providing an event that indicates whether the input is valid to the control and zero or more ancestors of the control; and
performing an action by the control or one of its ancestor if the input is not valid.

14. The method of claim 13, wherein the validation rule is associated with a Binding that associates the control with a data source, wherein the Binding executes the validation rule when attempting to update the data source with the input.

15. The method of claim 13, wherein the event is first provided to the control and, if the control does not acknowledge the event, is then provided to ancestors of the control in a closest-ancestor first order until one of the ancestors acknowledges the event.

16. The method of claim 13, wherein the action comprises changing a user interface that includes a visual representation of the control to indicate that the input is not valid, wherein changing the user interface comprises providing visual elements indicated by an adorner.

17. At least one computer-readable medium containing instructions which when executed by a computer, perform actions, comprising:
receiving a value to be validated before updating a data source with the value; and
in response thereto, providing at least one output from a function that causes a validation rule to validate the value, wherein the validation rule is associated with a Binding that associates an input that receives the value to the data source.

18. The at least one computer-readable medium of claim 17, wherein the function comprises at least part of an application programming interface.

19. The at least one computer-readable medium of claim 17, wherein the at least one output comprises error content that includes a string that indicates why the value is invalid.

20. The at least one computer-readable medium of claim 17, wherein the at least one output comprises an indication as to whether the value is valid.
